(19) United States
(12) Patent Application Publication
(10) Pub. No.: US 2008/0309251 A1
(43) Pub. Date: Dec. 18, 2008

(54) DEVICE WITH IMPROVED DISPLAY ILLUMINATION AND METHOD THEREFORE

(75) Inventors: Juha Petri Matero, Hampshire (GB); Paivi Heikkila, Tampere (FI); Sanna Lindroos, Tampere (FI); Vesa Huotari, Tampere (FI); Sanna Koskinen, Tampere (FI)

Correspondence Address: PERMAN & GREEN, 425 POST ROAD, FAIRFIELD, CT, 06824, US

(73) Assignee: NOKIA CORPORATION, Espoo (FI)

(21) Appl. No.: 11/761,413

(22) Filed: Jun. 12, 2007

(51) Int. Cl. H05B 37/02

(52) U.S. Cl. 315/291

(57) ABSTRACT

A device having a display, an illuminator configured to illuminate the display and a multi-way input key configured to control the illuminator upon activation. The illuminator also has a power output, the output level being arranged to be regulated upon activation of the multi-way input key proportional to a physical movement activating the multi-way input key.

### TECHNICAL FIELD

The disclosed embodiments relate to display illumination in devices and in particular to display illumination in portable devices.

### BACKGROUND

Most devices available on the market today suffer from tradeoffs between screen visibility and battery longevity, that is the manufacturer and/or user has to select whether to have a fully viewable display or long battery power life. Usually this is solved by making the output level of some illuminator or illuminating means such as the lamp, LED or backlight illuminating the screen adjustable so that the user or the control unit such as the CPU of the device can regulate the power needed by the illuminator or illuminating means. This is usually done so that when the device has not been used for a while it enters a sleeping mode or state and turns off the display or the illuminator as the user most likely won't be looking at the display anyway. One drawback of this is that as the user takes up his device he can not read the display. This has been solved in the past by either pressing a certain key, such as the power key in Nokia 6210 or alternative functions of certain keys such as on the Nokia 9510 or the IBM ThinkPad laptop computer. All these solutions has the drawback that they are not intuitive and requires the user to find specific buttons which can be difficult in dark environments especially when the device also has some keylock function activated.

### SUMMARY

In view of the above, it would be advantageous to solve or at least reduce the problems discussed above.

Generally, the aspects of the disclosed embodiments are achieved by the attached independent patent claims. According to a first aspect there has been provided a device comprising display means, illuminating means arranged to illuminate said display means and multi-way input means arranged to upon activation control said illuminating means and said illuminating means further having a power output and said output power is arranged to be regulated upon activation of said multi-way input means proportionately to a physical movement activating said multi-way input means.

Allowing the user to regulate the illumination in a proportionate way enables the user to save more power and in an easy and intuitive way. It should be noted that the illumination can be both to illuminate and to darken a display without having to wait for any timeouts or other functions the user is unable to control or regulate.

In another embodiment there is provided a device further comprising a control unit having two states, one active and one idle and wherein said control unit is adapted to execute user selected functions stored in a memory upon user selection and activation whereby the control unit assumes said active state and wherein said multi-way input means are arranged to control said illuminating means only when said control unit is in said idle state. This enables the illumination regulation to be used with keys normally associated with other tasks or functions thus not requiring any special hardware enabling a device to be made both smaller and to a lesser cost and also to allow downloading and&or installing of a software module implementing the teachings of this document in an existing device.

In a further embodiment there is provided a device wherein said output level can be regulated both up and down thereby enabling the user to save power without having to wait for timeouts and also to choose his own level of discretion. It should be noted that the illumination control or regulation of this document may also be combined with a timeout function so the user does not have to remember to turn off the illumination to save power.

In yet another embodiment a device is further arranged to receive user inputs and further having a locked state wherein user inputs other than the multi-way input means are ignored. This enables a more complex user interface system to use the teachings of this documents as it only acs in a special state where the input of any other input means are ignored anyway thus further enabling the use of already existing hardware.

In another embodiment there is provided a device wherein said multi-way input means is a scroller, rotator, slider or a joystick. These input keys have the benefit that they give a clear direction and also movement in that direction to make it easy for a user to control or regulate the illumination proportionate to his wishes in an intuitive manner.

According to another aspect of the teachings of this document there is provided a method for regulating the illumination of a display where in

### DESCRIPTION OF THE DRAWINGS

Devices according to the teachings of this document will now be described in greater detail with reference to the following figures.

FIG. 1 discloses a device according to the teachings of this application.

FIGS. 2a and b discloses a mobile phone according to the teachings of this application.

FIG. 3 discloses a personal digital assistant according to the teachings of this application.

FIG. 4 discloses a path finder according to the teachings of this application.

FIG. 5 discloses a method of operating a device in accordance with the teachings of this application.

### DETAILED DESCRIPTION

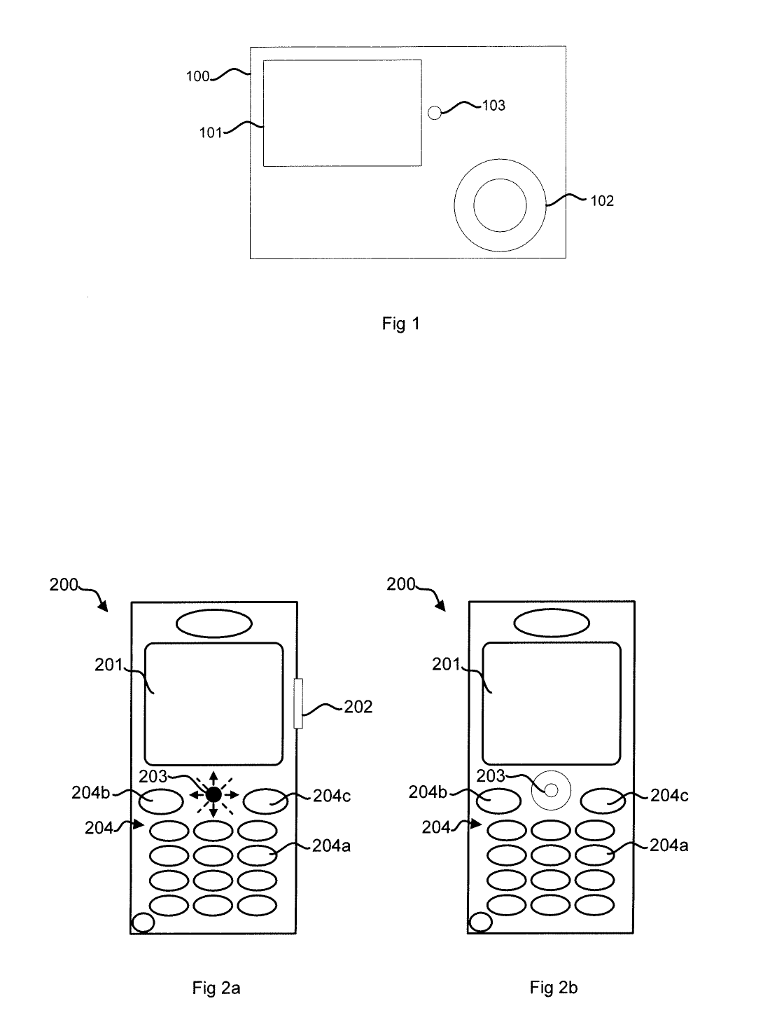

FIG. 1 shows a device 100, having a display 101 and multi-way input key 102, in this case a rotator. The display 101 is in this embodiment illuminated using a backlight functionality common to displays. In a mode commonly referred to as idle mode, i.e. when no user functionality, application or program is running, the display is often darkened to save power. In this state it can be difficult for a user to for example check the status or time as the display 101 is so dark. As a user rotates the rotator 102 a little bit the display is illuminated accordingly, i.e. only a little bit. If the user continues to rotate the display 101 is further illuminated all in proportion to how much the rotator 102 is rotated. If the user, after having seen the information needed wants to darken the display 101 again to save power he can now simply rotate in the other direction whereupon the display 101 is darkened accordingly. The display has a specific output level set for its backlight and by varying this output level it is easy to regulate the amount of illumination and also the power necessary and no other hardware needs to used. In this way the user can easily regulate or control the illumination and the power consumption.

It should be noted that illuminating the display can also be done by using a separate illuminator 103 such as a lamp, an LED lamp or other illuminating device common in the contemporary market. Both when darkening or illuminating the display it is done by regulating the output level of the illuminator, i.e. whatever illuminates the display be it the backlight function, the lamp, the LED lamp or other illuminator.

Other multi-way input keys that work well with the disclosed embodiments are sliders, scrollers as in Nokia 7110 or joysticks as they all give a continuous movement and a distinct sense of direction associating the illumination with the physical movement needed to move or activate the input key in an intuitive way.

Furthermore a two-way input key provides an intuitive way of darkening the display as well.

It should also be understood that the display 101 can also be in the form of at least one LED or a touch screen. If a touch screen is used the multi-way key could be a virtual key.

FIG. 2a shows a mobile communications device 200 such as a mobile phone having a display 201, a control unit (not shown), a memory (not shown) for storing applications and a slider 202 and also a joystick 203. The control unit is arranged to execute programs or applications stored in and fetched from the memory. If no program is actively running and having been started by the user, i.e. in an active state, or if the control unit is simply waiting for input but none have been received in within a certain time the phone may go into a resting mode, called an idle mode, upon which the display 201 could be dimmed to save power as the user is not looking at the screen anyway. If the slider 202 is activated during this idle mode the display is illuminated accordingly. If the slider 202 is moved a long way from its starting position the display is illuminated a lot. The same if the slider 202 is then moved in the other direction the display is darkened accordingly.

The same feature of controlling the illumination could be implemented using the joystick 203. If the joystick is analogue the display 201 would be illuminated according to how far the joystick is moved from its center.

It should be understood that it is not necessary to have both a slider and a joystick and that they are, from this document's point of view, only alternatives for implementing the teachings herein. It should also be understood that other input means such as mentioned above are also useful for implementing these teachings.

It should also be noted that a rotator is highly advantageous to be used in all of the described embodiments especially for a mobile phone as the rotator is easy to find among all the other keys of a phone especially in the dark. FIG. 2b shows such a mobile phone 200 having a rotator 203 instead of the joystick 203 and without the slider 202. The movement in any direction is also endless giving many alternatives as to how fast the illumination should change and in which direction, thus showing some advantages not displayed by all the other keys mentioned. This also holds true for virtual rotators and also for the embodiment described below where a virtual slider is set to have the whole touchscreen as active surface when implementing this feature.

The phone also has other keys 204, such as softkeys 204b and 204c and alphanumeric keys 204a, for input of data and control info to the other various functions of the phone 200. If the phone 200 has a keypad lock mode, commonly known to the skilled person, whereupon all key input except the key unlock command are ignored, the slider 202 (or other input means as mentioned above) could be accepted to illuminate the display 201. Note that the keypad lock function may also be implemented in any of the other devise shown in this document and used according to the teachings herein.

This provides the user with a simple and intuitive way of illuminating the display without having to unlock the keypad and then locking it again. These locking and unlocking operations can require quite a few keypresses and be quite annoying. And this without risking any erroneous activation of any of the phone's other functions.

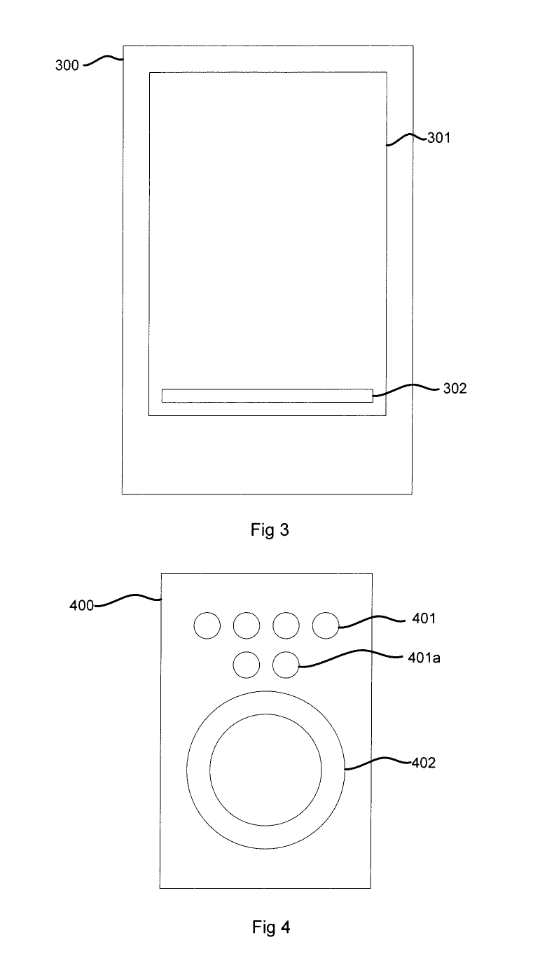

FIG. 3 shows a personal digital assistant 300, PDA, having a display in the form of a touchscreen 301, a controller (not shown) and a memory (not shown). When the PDA 300 is turned on a slider 302 is presented on the touchscreen acting as a two-way input key. When the PDA 300 is in idle mode, as previously explained, only the area of the touchscreen 301 representing the slider 302 is accepting input and only for controlling or regulating the illumination of the display 301.

It should be noted that the whole touch screen can be acting as a slider for the purposes of implementing the teachings of this document. In this manner it does not mater where the user touches the touch screen, it will be interpreted as a command to control the illumination of the touch screen 301 and the illumination will be according to the movement of the finger or stylus on the touch screen 301.

FIG. 4 shows a direction finder 400 having a display 401 in the form of an array of LEDs marking the strength of a received signal. As the signal grows stronger more LEDs are illuminated and the user can easily find out which direction to proceed in. If a user is walking or traveling longer distances it becomes less necessary to check the direction often and the LEDs can be dimmed to save power. The pathfinder also has a two-way input key in the form of a scroller or rotator 402 for inputting certain data such as selecting channel for example; the channels can also be shown on LEDs 401a making part of the display 401. As the user scrolls the rotator 402 when the pathfinder is otherwise idle he can regulate the power of the LEDs so he can quickly illuminate them, check the direction and then just as easily dim them again thus saving power.

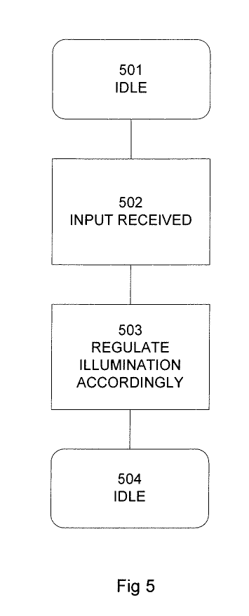

FIG. 5 shows a simple flow chart for implementing the teachings of this document. A device starts in an idle state 501 and as input is received from the two-way input key 502 the illumination of a display is regulated accordingly 503 and the device then returns to idle mode again. This method is explained in further detail in the description of the different devices above.

Other devices suitable for use are music players, media players, beepers, navigation aids, GPS receivers and laptops.

Devices as above without an illumination feature as described above could have one installed by downloading software implementing such an illumination feature. A separate component containing implementing said feature could also be installed or added to a device. An example of such a component could be an active cover for a mobile phone alternatively having its own two/way input key or using one of the devices being attached as well as the necessary software for executing the feature.

The devices shown are all portable and also battery powered. It should be noted that the feature may be used also for other stationary devices and also non-battery powered devices where the power consumption could be kept to a minimum for other reasons such as environmental or for purposes of discreteness.

It should be noted that the functions of the illumination of the display as described above for the various embodiments hold true for all the other embodiments and variations as well.

It should also be noted that software or other component suitable for installment in devise can be used for implementing the illuminating functionalities as described above and maybe downloaded to or installed in any suitable device.

1. Device comprising display means, illuminating means arranged to illuminate said display means and multi-way input means arranged to upon activation control said illuminating means and said illuminating means further having a power output and said output level is arranged to be regulated upon activation of said multi-way input means proportionately to a physical movement activating said multi-way input means.

2. Device according to claim 1 further comprising a control unit having two states, one active and one idle and wherein said control unit is adapted to execute user selected functions stored in a memory upon user selection and activation whereby the control unit assumes said active state and wherein said multi-way input means are arranged to control said illuminating means only when said control unit is in said idle state.

3. Device according to claim 1 wherein said output level can be regulated both up and down.

4. Device according to claim 1 arranged to receive user inputs and further having a locked state wherein user inputs other than the multi-way input means are ignored.

5. Device according to claim 1 wherein said multi-way input means is a scroller, rotator, slider or a joystick.

6. Device according to claim 1 wherein said multi-way input means are virtual and said display means is a touch screen.

7. Device according to claim 1 wherein said display means comprises at least one LED and illuminating means is same said at least one LED.

8. Device according to claim 1 wherein said display means comprises a backlight and wherein said illuminating means are said display means' backlight.

9. Device according to claim 1 wherein said device is portable

10. Device according to claim 1 wherein said device is battery powered

11. Device according to claim 1 wherein said device is a mobile communication device.

12. Device comprising a display, illuminator arranged to illuminate said display and multi-way input key arranged to control said illuminator upon activation and said illuminator further having a power output and said output level is arranged to be regulated upon activation of said multi-way input key proportionate to a physical movement activating said multi-way input key.

13. Device according to claim 12 further comprising a control unit having two states, one active and one idle and wherein said control unit is adapted to execute user selected functions stored in a memory upon user selection and activation whereby the control unit assumes said active state and wherein said multi-way input key is arranged to control said illuminator only when said control unit is in said idle state.

14. Device according to claim 12 wherein said output level can be regulated both up and down.

15. Device according to claim 12 arranged to receive user inputs and further having a locked state wherein user inputs other than the scroll input key are ignored.

16. Device according to claim 12 wherein said multi-way input key is a scroller, rotator, slider or a joystick.

17. Device according to claim 12 wherein said multi-way input key is virtual and said display is a touch screen.

18. Device according to claim 12 wherein said display comprises at least one LED and said illuminator is same said at least one LED.

19. Device according to claim 12 wherein said display comprises a backlight and wherein said illuminator is said display's backlight.

20. Device according to claim 12 wherein said device is portable

21. Device according to claim 12 wherein said device is battery powered

22. Device according to claim 12 wherein said device is a mobile communication apparatus.

23. Method for controlling an illumination of a display on a device comprising an illuminator arranged to illuminate said display and a multi-way input key wherein
user input is received through said multi-way input key and
an output level of said illuminator is regulated accordingly.

24. Method according to claim 23 wherein said user input is dependent on a physical movement activating said multi-way input key and said illuminator is regulated proportionately to this movement.

25. Method according to claim 23 wherein said illuminator is regulated by regulating an output level of said illuminator.

26. Method according to claim 23 wherein said regulation is only performed if said device is in an idle state.

27. Method according to claim 23 wherein said regulation is only performed if said device is in a key locked state.

28. Component for implementing a method as in claim 23.

29. Software arranged to implement a method as in claim 23 when executed through a control unit.
